(19) United States
(12) Patent Application Publication
(10) Pub. No.: US 2007/0002316 A1
(43) Pub. Date: Jan. 4, 2007

(54) Wafer aligner, semiconductor manufacturing equipment, and method for detecting particles on a wafer

(76) Inventor: Jung-Min Choi, Incheon-si (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/474,381

(22) Filed: Jun. 26, 2006

(30) Foreign Application Priority Data
Jun. 29, 2005 (KR) 2005 57242

(51) Int. Cl. G01N 21/88

(52) U.S. Cl. 356/237.2

(57) ABSTRACT

A wafer aligner may comprise a chuck which supports a wafer thereon. The wafer aligner may also comprise a particle detector which irradiates a light onto a back surface of the wafer loaded on the chuck and receives a light reflected from the back surface of the wafer to output a detection signal. The wafer aligner may also comprise a controller which checks whether a particle exists on the back surface of the wafer based on the detection signal from the particle detector, and causes the wafer aligner to enter an interlock state when the particle exists on the back surface of the wafer.

### BACKGROUND OF THE INVENTION

1. Field of the Invention

The present invention relates to a semiconductor manufacturing equipment and method and, more particularly, to systems and methods for detecting a particle on a back surface of a wafer in semiconductor manufacturing equipment.

A claim of priority is made to Korean Patent Application No. 2005-57242 filed on Jun. 29, 2005, the disclosure of which is hereby incorporated by reference in its entirety.

2. Description of the Related Art

In general, a conventional semiconductor manufacturing equipment includes a plurality of load ports. These load ports may be used for loading a cassette that carries a plurality of wafers. In addition, semiconductor manufacturing equipment may also include one or more wafer aligners between process chambers. Wafer aligners may detect a notch position of a wafer and set the wafer in an aligned position before the wafer is transferred to the process chamber for an etch process.

The back surface of the wafer is often contaminated by particles from previous work processes. When the contaminated wafer is provided to the process chamber, it may cause various problems such as, for example, wafer chucking error and electrostatic chuck arching during the RF power supply. These problems may cause the stoppage of the etching process and/or may increase the time spent on preventive maintenance of the semiconductor manufacturing equipment. In addition, particles on the back surface of the wafer may cause a malfunction during the etch process and the following work processes, thereby lowering the productivity of the manufacturing process.

### SUMMARY OF THE INVENTION

One aspect of the present disclosure includes a wafer aligner. The wafer aligner may comprise a chuck which supports a wafer thereon. The wafer aligner may also comprise a particle detector which irradiates a light onto a back surface of the wafer loaded on the chuck and receives a light reflected from the back surface of the wafer to output a detection signal. The wafer aligner may also comprise a controller which checks whether a particle exists on the back surface of the wafer based on the detection signal from the particle detector, and causes the wafer aligner to enter an interlock state when the particle exists on the back surface of the wafer.

Another aspect of the present disclosure includes a method of detecting a particle on a wafer aligner. The method may comprise loading a wafer. The method may also comprise irradiating a light signal onto a back surface of the wafer. The method may also comprise receiving a light signal reflected from the back surface of the wafer. The method may also comprise checking whether a particle exists on the back surface of the wafer based on the light signal reflected from the back surface of the wafer. The method may also comprise causing the wafer aligner to enter an interlock state when the particle exists on the back surface of the wafer.

Yet another aspect of the present disclosure includes a semiconductor manufacturing equipment. The equipment may comprise at least one load port into which a cassette carrying a plurality of wafers is loaded. The equipment may also comprise at least one process chamber. The equipment may also comprise a load-lock chamber operatively coupled to the process chamber. The equipment may also comprise a transfer chamber positioned between the load port and the load-lock chamber, the transfer chamber being configured to transfer a wafer in the cassette between the load port and the load-lock chamber. The equipment may also comprise a wafer aligner which detects whether a particle exists on a back surface of the wafer when the wafer is transferred from the transfer chamber. The equipment may also comprise a controller which causes the wafer aligner to enter an interlock state when the particle exists on the back surface of the wafer.

Another aspect of the present disclosure includes a processing method for semiconductor manufacturing equipment. The method may comprise transferring a wafer to a transfer chamber from a cassette carrying a plurality of wafers. The method may also comprise loading the transferred wafer on a wafer aligner. The method may also comprise determining whether a particle exists on a back surface of the loaded wafer. The method may also comprise causing the semiconductor manufacturing equipment to enter an interlock state when the particle exists on the back surface of the wafer.

### BRIEF DESCRIPTION OF THE DRAWINGS

The above and other features and aspects of the present invention will become readily apparent from the detailed description that follows, with reference to the accompanying drawings, in which:

FIG. 1 is a plane view illustrating a semiconductor manufacturing equipment according to an exemplary embodiment of the present invention;

FIGS. 2 and 3 are views illustrating components of a wafer aligner shown in FIG. 1 according to an exemplary embodiment of the present invention; and

FIG. 4 is a flow chart illustrating a processing method for a semiconductor manufacturing equipment according to an exemplary embodiment of the present invention.

### DETAILED DESCRIPTION OF EXEMPLARY EMBODIMENTS

Hereinafter, embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the invention to those skilled in the art.

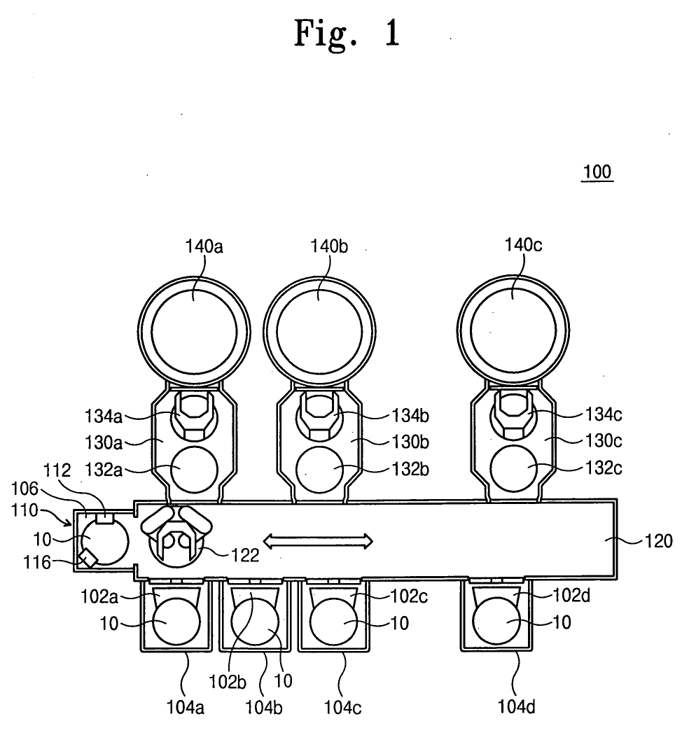

Referring to FIG. 1, semiconductor manufacturing equipment 100 includes a wafer aligner 110 that detects a particle on a back surface of a wafer. The semiconductor manufacturing equipment 100 also includes a transfer chamber 120 and a plurality of load-lock chambers 130a, 130b, and 130c. The transfer chamber 120 is located in between a plurality of load ports 104a, 104b, 104c, and 104d and a plurality of process chambers 140a, 140b, and 140c. The transfer chamber 120 transfers a wafer between the load ports 104a, 104b, 104c, and 104d and the process chambers 140a, 140b, and 140c. The load-lock chambers 130a, 130b, and 130c move a wafer between the transfer chamber 120 and each of the process chambers 140a, 140b, and 140c.

The wafer aligner 110 may be positioned adjacent to a side of the transfer chamber 120 such that the wafer can be transferred between the wafer aligner 110 and the transfer chamber 120. Furthermore, the wafer aligner 110 inspects whether a particle exists on a back surface of the wafer before the wafer is delivered to one of the process chambers 140a, 140b, or 140c. When there is no particle on the wafer, the wafer aligner 110 sets the wafer in an aligned position after reading identification (ID) information of the wafer and detecting a notch location of the wafer.

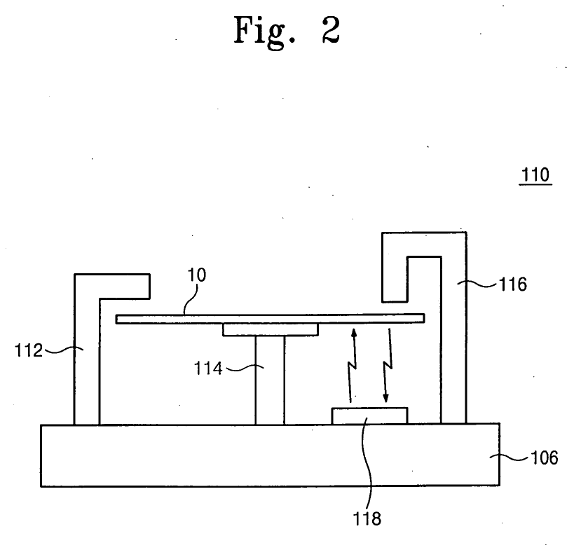

Referring to FIG. 2, the wafer aligner 110 includes a particle detector 118 on a table 106 next to the transfer chamber 120, an ID reader 116, and a notch detector 112. The particle detector 118 detects a particle that is on the back surface of the wafer. The wafer aligner 110 may allow any following work process to start on the wafer after ensuring that no particle is found on the wafer.

In the exemplary embodiment, the semiconductor manufacturing equipment 100 can be, for example, an etch process equipment. When a cassette 102a, 102b, 102c, and 102d carrying a plurality of wafers 10 (see FIG. 1) is loaded on at least one of the load ports 104a, 104b, 104c, and 104d, the wafer 10 is transferred to the wafer aligner 110 from one of the load ports 104a, 104b, 104c, and 104d by a transfer device 122 in the transfer chamber 120. This transfer may occur before the wafer 10 is delivered to the process chambers 140a, 140b, and 140c.

Each of the load ports 104a-104d loads the cassette 102a-102d carrying, for example, 25 sheets of the wafer 10. A plurality of the process chambers 140a-140c having load-lock chambers 130a-130c are located on the other side of the load ports 104a-104d. Each of the process chambers 140a-140c may perform work processes on the wafer 10 that are the same or different from one another.

Each of the load-lock chambers 130a-130c may include a buffer loader 132a-132c and a transfer robot 134a-134c to move the wafer 10 between the process chamber 140a-140c and the transfer chamber 120.

The transfer chamber 120 may include a plurality of robots (for example two robots) and transfer devices 122 that can move in a horizontal direction. The transfer device 122 may transfer the wafer 10 between the process chamber 140a-140c and the load ports 104a-104d by moving in the horizontal direction by raising, lowering or rotating the robots.

In addition, the transfer device 122 may also move the wafer 10 between the transfer chamber 120 and the wafer aligner 110. Specifically, the wafer aligner 110 may be located at a side of the transfer chamber 120 to check the position of the wafer 10 by detecting a notch (or a flat zone) of the wafer 10. The transfer device 122 may move the wafer 10 between the transfer chamber 120 and the wafer aligner 110 so that the wafer aligner 110 may check the position of the wafer 10.

As described above, the semiconductor manufacturing equipment 100 may transfer the wafer 10 from the cassette 102a-102d at each load port 104a-104d to the wafer aligner 110 with the wafer transfer device 122, before the work process on the wafer 10 begins in the process chamber 140a-140c. Furthermore, the wafer aligner 110 may exchange the wafer whose position is already checked, with a newly arrived wafer through the wafer transfer device 122.

The wafer aligner 110 inspects whether a particle exists on the back surface of the wafer before the wafer is delivered to the process chamber. If there is no particle on the back surface of the wafer, the wafer aligner 110 reads the identification information of the wafer and detects the notch of the wafer, thereby setting the wafer in an aligned position. Furthermore, based on the wafer identification information, the transfer device 122 moves the wafer to the load-lock chamber to allow the wafer to be transferred to a corresponding process chamber.

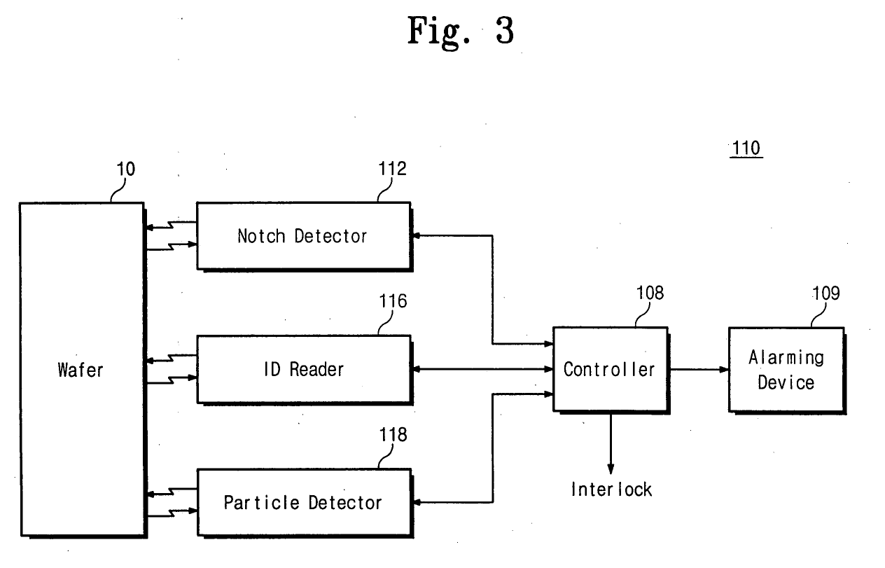

Referring to FIGS. 2 and 3, the wafer aligner 110 includes a wafer chuck 114 on the table 106 fixed to the side of the transfer chamber 120, the ID reader 116 for reading the identification (ID) information of the wafer 10 that is loaded on the wafer chuck 114, the notch detector 112 for detecting the notch of the loaded wafer 10 in order to set the wafer 10 in an aligned position, and a particle detector 118 for detecting a particle on the back surface of the wafer 10 loaded on the wafer chuck 114. The wafer chuck 114 may be connected to an actuator (not shown) that rotates the wafer chuck 114 when the wafer 10 is loaded on the wafer chuck 114.

The wafer aligner 110 may further include a controller 108. Controller 108 may be electrically connected to the ID reader 116, the notch detector 112, the particle detector 118, the actuator, and an alarming device 109. The alarming device 109 may be controlled by the controller 108 to output an alarm signal when there is a particle on the back surface of the wafer 10.

The particle detector 118 includes, for example, a light sensor or an image sensor to detect flatness or deflection off the back surface of the wafer 10. Specifically, the particle detector 118 may detect particles based on the intensity of the light signal or the image data. This is because the back surface of the wafer may be deformed when there is a particle on the back surface of the wafer.

In an exemplary embodiment, the particle detector 118 may include a light sensor controlled by the controller 108. Specifically, the light sensor may irradiate a light signal on the back surface of the wafer 10 loaded on the wafer chuck 114. Furthermore, the light sensor may receive the light signal reflected from the back surface of the wafer 10 and send the light signal to the controller 108. In an alternative exemplary embodiment, the particle detector 118 may include an image sensor, such as, for example, a CCD image sensor, or a CMOS image sensor. In this embodiment, the controller 108 may control the image sensor to irradiate a light signal onto the back surface of the wafer 10 when the wafer 10 is loaded on the wafer chuck 114. Furthermore, the image sensor receives the light signal reflected from the back surface of the wafer 10 and transforms the light signal into an image data to transfer the image data to the controller 108. The particle detector 118 may be bar shaped to irradiate the light signal entirely onto the back surface of the wafer 10. The controller 108 may control the actuator to rotate the wafer chuck 114 so the particle detector 114 may irradiate the light signal entirely onto the back surface of the wafer 10.

The controller 108 may control the particle detector 118 to irradiate the light signal onto the back surface of the wafer 10 when the wafer 10 is delivered from the transfer chamber 120 and loaded on the wafer chuck 114. The light signal irradiated by the particle detector 118 is reflected from the back surface of the wafer 10 and the information of the reflected light signal such as light intensity or image data is retrieved by the controller 108. The controller 108 determines whether any particle exists on the back surface of the wafer 10 by analyzing the light intensity or the image data which are retrieved from the particle detector 118.

When there is a particle on the back surface of the wafer 10, the controller 108 may generate an interlock state to stop the operation of the particle detector 114. In the interlock state, the controller 108 stops the actuator that is connected to the wafer chuck 114 and controls the alarming device 109 to generate the alarm signal. Consequently, the contaminated wafer is stopped before it proceeds to the next work process and can be readily removed by a worker. When no particle is found on the back surface of the wafer 10, the controller 108 reads the ID information of the wafer 10 from the ID reader 116 and controls the notch detector 112 and the actuator to align the wafer 10.

As described above, the wafer aligner 110 may determine whether a particle exists on the back surface of the wafer before the wafer proceeds to the process chamber 140a-140c of the semiconductor manufacturing equipment 100. This determination may prevent a malfunction in the subsequent work processes and may thus enhance productivity.

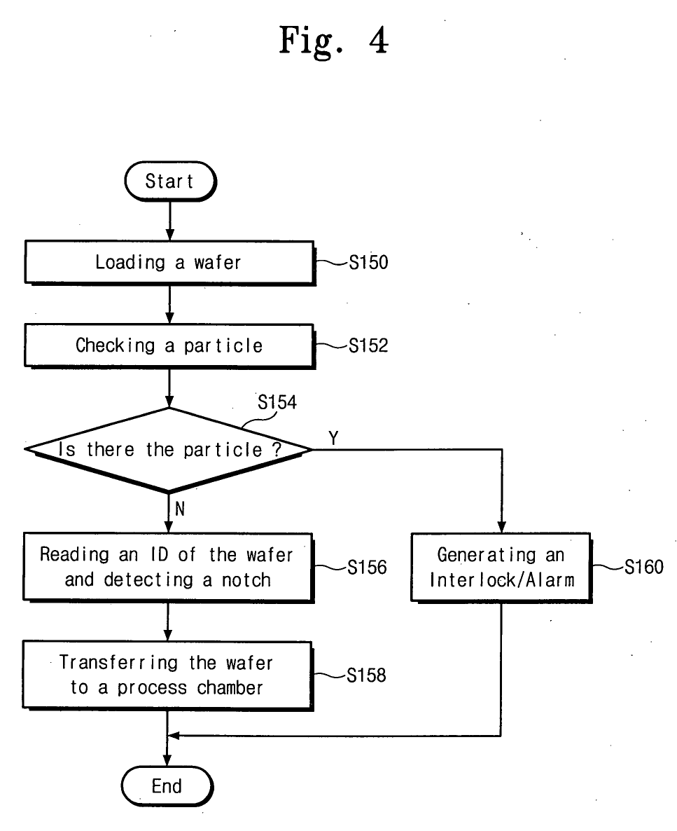

FIG. 4 is a flow chart illustrating a processing method of a semiconductor manufacturing equipment according to an exemplary embodiment of the present invention. In an exemplary embodiment, this procedure is a program executed by the controller 108. This program may be stored in a storage unit such as, for example, a memory (not shown), of the controller 108.

Referring to FIG. 4, when the wafer 10 is loaded on the wafer chuck 114 (step S150), the controller 108 controls the particle detector 118 to irradiate a light signal onto the back surface of the wafer 10 and receive a light signal reflected from the back surface of the wafer 10 (step S152). That is, the particle detector 118 provides the controller 108 with the received light signal.

The controller 108 checks whether a particle exists on the back surface of the wafer 100 based on the light signal from the particle detector 118 (step S154). Specifically, when the particle detector 118 includes a light sensor, the controller 118 analyzes the light intensity of the light signal reflected from the back surface of the wafer 10 to check whether a particle exists on the back surface of the wafer 10. Alternatively, when the particle detector 118 includes an image sensor, the controller 118 determines whether a particle exists on the back surface of the wafer 10 based on the image data of the back surface of the wafer 10.

When a particle exists on the back surface of the wafer 10, the controller 108 generates the interlock state to stop the operation of the wafer aligner 110 and generates the alarm signal so that the contaminated wafer can be removed by the worker (step S160).

On the other hand, when no particle is found on the back surface of the wafer, the controller 108 controls the ID reader 116 to read the ID information of the wafer 10 loaded on the wafer chuck 114 and controls the notch detector 112 to detect the notch of the wafer 10 to align the wafer 10 (step S156). Furthermore, the controller 108 delivers the aligned wafer 10 to the process chambers 140a-140c according to the ID information, via the transfer chamber 120 and the load-lock chamber 130a-130c.

As described above, the semiconductor manufacturing equipment 100 includes the wafer aligner 110 that determines whether a particle exists on the back surface of the wafer before the wafer 10 is delivered to the subsequent work processes. When no particle is found on the back surface of the wafer, the ID information is read and the notch location is identified so that the wafer can be set in an aligned position before the wafer is transferred to the process chamber. This process may prevent the malfunctioning of process equipment, and consequently, the deterioration in productivity of the wafer.

Although the present invention has been described in connection with the embodiment of the present invention illustrated in the accompanying drawings, it is not limited thereto. It will be apparent to those skilled in the art that various substitution, modifications and changes may be thereto without departing from the scope and spirit of the invention. It is intended that the specification and the examples be considered exemplary only, with a true scope of the disclosure being indicated by the following claims and their equivalents.

What is claimed is:

1. A wafer aligner comprising:
a chuck which supports a wafer;
a particle detector which irradiates a light onto a back surface of the wafer supported by the chuck and which receives a light reflected from the back surface of the wafer to output a detection signal; and
a controller which checks whether a particle exists on the back surface of the wafer based on the detection signal from the particle detector, and which causes the wafer aligner to enter an interlock state when the particle exists on the back surface of the wafer.

2. The wafer aligner of claim 1, further comprising a reader which reads identification information of the wafer supported by the chuck.

3. The wafer aligner of claim 1, further comprising a notch detector which detects a notch to set the wafer in an aligned position on the chuck.

4. The wafer aligner of claim 1, wherein the detection signal is indicative of light intensity of at least the light reflected from the back surface of the wafer.

5. The wafer aligner of claim 1, wherein the detection signal includes image data indicative of an image of the back surface of the wafer.

6. The wafer aligner of claim 1, further comprising an alarming device which is controlled by the controller, wherein the alarming device generates an alarm when the interlock state is entered.

7. A method of controlling a wafer aligner, the method comprising:
loading a wafer;
irradiating a light signal onto a back surface of the wafer;
receiving a light signal reflected from the back surface of the wafer;
checking whether a particle exists on the back surface of the wafer based on the light signal reflected from the back surface of the wafer; and
causing the wafer aligner to enter an interlock state when the particle exists on the back surface of the wafer.

8. The method of claim 7, further comprising generating an alarm when the interlock state is entered.

9. The method of claim 7, wherein the checking of whether the particle exists on the back surface of the wafer is executed based upon an intensity of the light signal reflected from the back surface of the wafer.

10. The method of claim 7, wherein the checking of whether the particle exists on the back surface of the wafer is performed based upon an analysis of image data obtained from the light signal reflected from the back surface of the wafer.

11. A semiconductor manufacturing equipment comprising:
a load port on which a cassette carrying a plurality of wafers is loaded;
a process chamber;
a load-lock chamber operatively coupled to the process chamber;
a transfer chamber positioned between the load port and the load-lock chamber, the transfer chamber being configured to transfer a wafer in the cassette between the load port and the load-lock chamber;
a wafer aligner which detects whether a particle exists on a back surface of the wafer when the wafer is transferred from the transfer chamber; and
a controller which causes the wafer aligner to enter an interlock state when the particle exists on the back surface of the wafer.

12. The semiconductor manufacturing equipment of claim 11, wherein the process chamber is an etch chamber.

13. The semiconductor manufacturing equipment of claim 11, wherein the wafer aligner comprises:
a chuck which supports a wafer;
a particle detector which irradiates a light signal onto the back surface of the wafer supported by the chuck and receives a light signal reflected from the back surface of the wafer;
a reader which reads an identification information of the wafer supported by the chuck; and
a notch detector which detects a notch in order to set the wafer supported by the chuck in an aligned position.

14. The semiconductor manufacturing equipment of claim 13, wherein the particle detector includes at least one of a light sensor and an image sensor.

15. The semiconductor manufacturing equipment of claim 12, further comprising an alarming device which generates an alarm when the wafer aligner enters the interlock state.

16. A processing method for a semiconductor manufacturing equipment, the method comprising:
transferring a wafer to a transfer chamber from a cassette carrying a plurality of wafers;
loading the transferred wafer onto a wafer aligner;
determining whether a particle exists on a back surface of the loaded wafer; and
causing the semiconductor manufacturing equipment to enter an interlock state when the particle exists on the back surface of the wafer.

17. The method of claim 16, further comprising reading an identification information of the loaded wafer when the particle does not exist on the back surface of the loaded wafer and detecting a position of a notch to align the wafer.

18. The method of claim 17, further comprising transferring the wafer to a process chamber from the transfer chamber after the aligned wafer is transferred to the transfer chamber.

19. The method of claim 16, further comprising generating an alarm when semiconductor manufacturing enters the interlock state.
